(19) United States
(12) Patent Application Publication
(10) Pub. No.: US 2014/0083826 A1
(43) Pub. Date: Mar. 27, 2014

(54) Bicycle Bell Using Brake Lever

(71) Applicants: Lee H. Greenberg, Greenbrae, CA (US); Manuel L. Karell, Alameda, CA (US)

(72) Inventors: Lee H. Greenberg, Greenbrae, CA (US); Manuel L. Karell, Alameda, CA (US)

(21) Appl. No.: 13/626,883

(22) Filed: Sep. 26, 2012

(51) Int. Cl. G10K 1/072; H01H 3/16

(52) U.S. Cl. 200/61.12; 116/148

(57) ABSTRACT

A handlebar-mounted-bicycle-brake-component having a bicycle bell drum mounted on the cable housing and a bell striker mounted on the brake lever. The bell is rung by quickly releasing the brake lever. An analogous concept is having an electrical switch mounted to replace the bell.

### BACKGROUND OF THE INVENTION

1. Field of Invention

The invention relates to bicycle bells and/or electrical contacts utilizing the handle bar mounted cable housing and associated brake lever.

2. Description of Related Art

Conventionally, a bicycle warning bell is mounted on the handlebar requiring the rider to remover his or her hand from the brake to operate the bell. Prior art has arranged the bell to be placed on the brake cable housing allowing the operation of the bell without removing the hand from the brake. Various patents exist such as U.S. Pat. Nos. 7,424,863, and 7,806,071 that use the hand brake cable housing of a bicycle hand brake as a platform to mount a bell, consisting of, in its simplest form, a bell dome, a spring loaded clapper and a lever. Activation of this simple bell is accomplished by using the index finger or thumb to depress and quickly release the bell lever, causing the clapper to strike the bell dome.

Conventionally, a bicycle or motorcycle button switch is mounted on the handlebar causing the rider to take his or her hand off the brake lever or other lever and move the hand to press the button switch to cause a closing of the switch operatively connected to a bell, or siren, or light or other purpose. Prior art of switches in brake levers exist as in U.S. Pat. No. 6,729,750.

### SUMMARY OF THE INVENTION

The current invention is an improvement in that it combines the functions of the handle bar mounted brake component and the bicycle bell thus saving manufacturing costs. Safety is preserved as the hand does not have to leave the brake to activate this bell.

The upper cable housing is modified to accept a bell dome on stalk. The already spring loaded hand brake lever is modified to accept a flexible striker post that supports a clapper. At rest, with brake not activated, the clapper and bell rest in close proximity on their respective components separated by a gap.

Background:

As to the brake system, when normally installed there is a small amount of “free play” in the system to insure that the brake pads fully withdraw after engagement and do not contact the bicycle rim unless the brake lever is purposely engaged.

Operation:

To ring the bell in the above described configuration, the brake lever is squeezed to the extent that the free play allows without engaging the brake, and quickly released. Upon release the spring loaded brake lever will snap closed carrying the flexible shaft mounted striker/clapper with it. Because the bell striker has built up momentum it will continue to travel forward, closing gap, striking the bell dome and ringing the bell. The number and volume of chime will depend on the weight of the striker, flexibility of the shaft, and width of the gap. This squeeze/ release action can be repeated quite rapidly as needed. Note that the addition of the bell dome to the cable housing, or the addition of the shaft mounted clapper to the brake lever will not interfere with the normal operation of the hand brake.

As to the striker, it may be mounted vertically for simplicity of design, manufacture, and assembly. The brake lever could have a hole to receive the striker assembly. The striker could then be just a plastic peg with a formed stop near one end and a formed clapper bulb at the other end. The peg end is to be inserted into the hole. Or the striker assembly could be composed of a peg, a length of spring, and the striker bulb. Or the ends of the spring could be unwound and straightened where one end may be inserted into hole in the brake lever, the other end may be inserted into clapper bulb. In any case sticker shaft/clapper bulb assembly would all be in a straight line with no bends necessary or wanted. By being some form of a straight affair there will be no issue of orientation. Simply insert the peg end into the hole. The striker shaft may be extended beyond bulb and therefore it is possible to “flick” the striker with the index finger thus ringing the bell without removing fingers from levers.

As to mounting the bell: These cable housings are generally cast. The castings could be modified to include a volcano like protuberance having a center hole in it. Into this hole would be inserted a peg with the bell dome attached to it.

It is therefore one object of the invention to provide a bicycle bell mounted on the brake cable housing and a bell striker to be mounted on the associated brake lever thereby utilizing the already present handlebar mounted brake components.

It is another object of the invention to provide an electric contact mounted on the brake housing and a striker-electric contact to be mounted on a brake lever thereby using the already present brake components to make an electrical contact and closing a switch for use with electronic bell, siren, and or lights or other purpose.

It is another object of the invention to provide the bell striker to have a spring shaft to increase bell striker force/momentum against the drum.

It is another object of the invention to provide the bell striker to have a weighted clapper head to increase bell striker force/momentum against the drum.

It is another object of the invention to provide the components to the invention may be manufactured in unity or as add-on.

The above and other objects, features and advantages of the invention will become apparent from the following detailed description taken with the accompanying drawings.

### BRIEF DESCRIPTION OF THE DRAWINGS

FIG. 1 is a view of a bicycle bell mounted on top of a handlebar-mounted-bicycle-brake component

FIG. 2 is a view of a bicycle bell mounted on side of a handlebar-mounted-bicycle-brake component

FIG. 3 is a view of a bell striker having a spring in the shaft and with weighted clapper head

FIG. 4 is a side view of electrical contacts mounted on a handlebar-mounted-bicycle-brake component

### DETAILED DESCRIPTION OF THE INVENTION

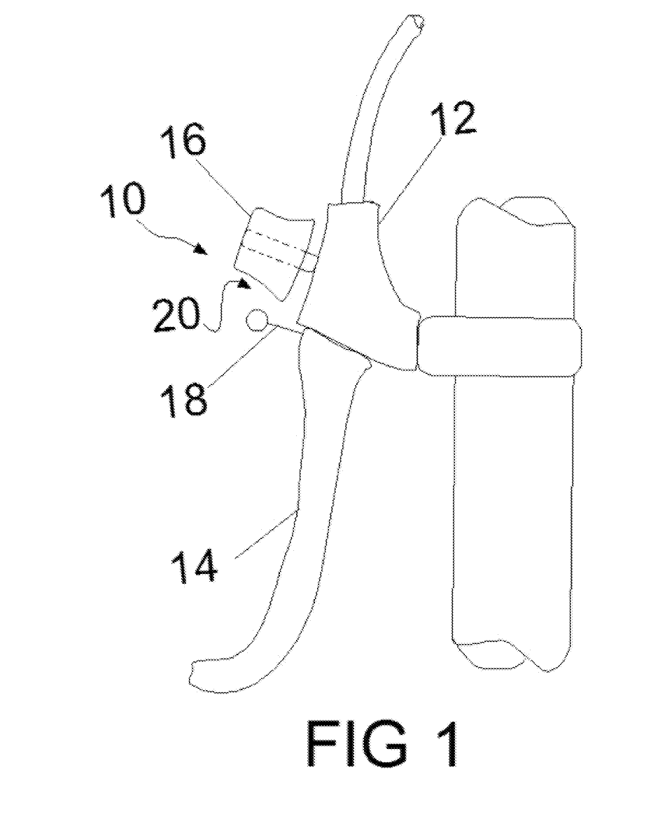

Referring to FIG. 1 an embodiment of a bell, invention 10, mounted on top of a handlebar-mounted-bicycle-brake-component comprising the following components in which the cable housing 12 is provided with a spring loaded brake lever 14 being operatively connected thereto. The cable housing 12 is mounted (prior art not described) on a handlebar. The cable housing 12 is adapted to comprise a bell drum 16 mounted on the top; the spring loaded brake lever 14 is adapted to comprise a bell striker 18 mounted on the top. There is gap 20 between bell striker 18 and bell drum 16. In operation, the rider quickly releases spring loaded brake lever 14 which causes bell striker 18 to close gap 20 and hit bell drum 16 to ring the bell. A spring to provide force for the released brake is prior art and is not shown.

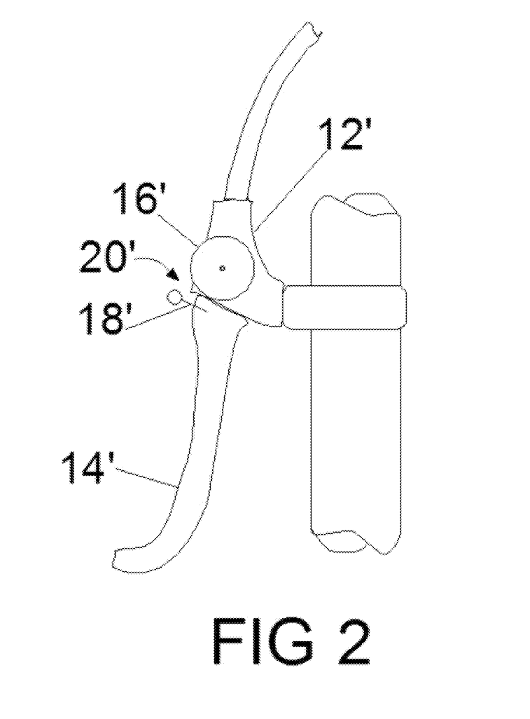

FIG. 2 is a view of an alternative embodiment of invention 10, comprises the following components in which a bell is mounted on the side: a cable housing 12′ is provided with a spring loaded brake lever 14′ being operatively connected thereto. The cable housing 12′ is mounted (prior art not described) on a handlebar. The cable housing 12′ is adapted to comprise a bell drum 16′ mounted on the side; the spring loaded brake lever 14′ is adapted to comprise a bell striker 18′ mounted on the side. Gap 20′ is between bell drum 16′ and bell striker 18′. In operation, the rider quickly releases spring loaded brake lever 14′ which causes bell striker 18′ to close gap 20′ and to hit bell drum 16′ to ring the bell. A spring to provide force for the released brake is prior art and is not shown.

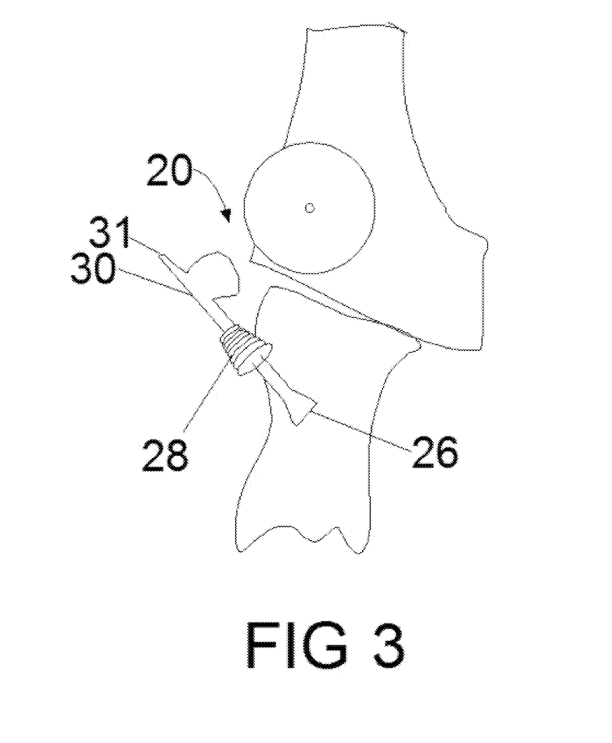

FIG. 3 is a view of a bell striker comprising a shaft 26 operatively connected to a spring 28 operatively connected to weighted striker head 30. In operation the brake lever is quickly released to cause striker head to close gap to ring bell. FIG. 3 also shows extension of shaft 31 beyond weighted striker head 30 which can be rider operated with finger to ring bell.

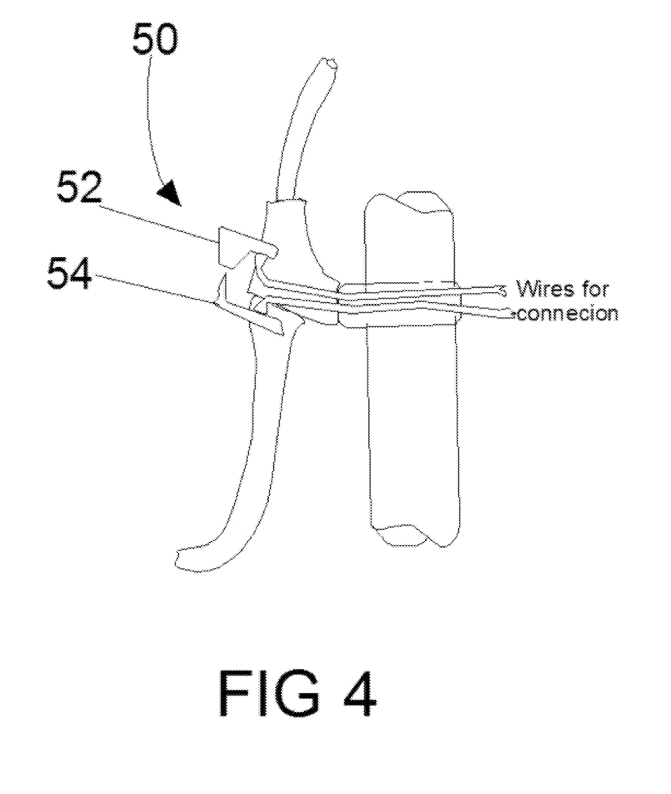

FIG. 4 is a view of the analogous invention concept 50 wherein a handlebar-mounted-bicycle-brake-component comprises the following components in which an electrical switch is mounted on the top or side: a cable housing is provided with a spring loaded brake lever being operatively connected thereto. The cable housing is mounted on a handlebar. The cable housing is adapted to comprise a first electric contact 52 mounted on the top or side; the spring loaded brake lever is adapted to comprise a second electric contact 54 mounted on the top or side. In operation, the rider quickly releases spring loaded brake lever which causes second electric contact 54 to hit the first electric contact 52 to close the switch, thereby ringing bell, or siren, or turning on lights or other purpose.

What is claimed is:

1. A bicycle bell incorporating a handlebar-mounted-bicycle-brake-component comprising:
a cable housing adapted to be operationally connected to a spring loaded brake lever wherein said cable housing is adapted to contain a bell drum; and wherein said spring loaded brake lever is adapted to contain a bell striker; and wherein said spring loaded brake lever is to exert a force such that when the rider releases said spring loaded brake lever said bell striker is caused to ring said bell drum of said bicycle bell.

2. A handlebar-mounted-bicycle-brake-component having an electric switch comprising:
a cable housing adapted to be operationally connected with a spring loaded brake lever wherein said cable housing is adapted to contain a first electric contact; and wherein said spring loaded brake lever is adapted to contain a second electric contact; and
wherein said spring loaded brake lever is to exert a force such that when the rider releases said spring loaded brake lever causing said second electrical contact to make contact with said first electrical contact for closing said electric switch.

3. A bicycle bell of claim 1 wherein said bicycle bell drum is located on the top portion of said cable housing and wherein said bell striker is located on the top portion of said spring loaded brake lever.

4. A handlebar-mounted-bicycle-brake-component of claim 1 wherein said bicycle bell drum is located on the side portion of said cable housing and wherein said bell striker is located on the side portion of said brake lever.

5. A bell striker of claim 1, 3, 4 wherein said bell striker comprises a spring shaft to allow momentum to carry the bell striker into the bell drum.

6. A bell striker of claim 1, 3, 4 wherein said bell striker comprises a weighted clapper to enhance potential striking force.

7. An apparatus of claim 1, 2, 3, 4, 5, 6 wherein during manufacture components are in unity.

8. An apparatus of claim 1, 2, 3, 4, 5, 6 wherein during manufacture components are in not in unity.
